(19) United States
(12) Patent Application Publication
(10) Pub. No.: US 2016/0055450 A1
(43) Pub. Date: Feb. 25, 2016

(54) Systems for Dynamically Assigning Content to be Displayed on a Digital Sign

(71) Applicant: Lexmark International Technology S.A., Meyrin (CH)

(72) Inventors: Eric Nicholas Bedell, Guilford, CT (US); Samuel William Gardiner, Lexington, KY (US); Andrew Roger Mattice, Seattle, WA (US); Brant Dennis Nystrom, Lexington, KY (US); Sunil Reddy Ravula, Lexington, KY (US); Dean Arthur Sleeper, Seattle, WA (US); Forrest Lane Steely, Lexington, KY (US)

(21) Appl. No.: 14/584,303

(22) Filed: Dec. 29, 2014

Related U.S. Application Data
(60) Provisional application No. 62/040,891, filed on Aug. 22, 2014.

(51) Int. Cl. G06Q 10/08; G06F 17/30; G06K 7/10

(52) U.S. Cl. CPC G06Q 10/087; G06K 7/10881; G06K 7/1095; G06F 17/30879; G06F 17/30525; G06F 17/30554

(57) ABSTRACT

A system having a display-data server is disclosed. The display-data server is configured to receive from a hand-held scanner a product identifier that identifies a retail product, receive from the hand-held scanner a sign identifier that identifies a digital sign, and route a display data to the digital sign identified by the sign identifier. Other systems are disclosed.

### CROSS REFERENCES TO RELATED APPLICATIONS

The present application is related to and claims priority under 35 U.S.C. §119(e) from U.S. provisional application No. 62/040,891, filed Aug. 22, 2014, entitled “SYSTEMS AND METHODS FOR DYNAMICALLY ASSIGNING CONTENT TO BE DISPLAYED ON A DIGITAL SIGN,” the content of which is hereby incorporated by reference herein in its entirety. The present application also relates to U.S. non-provisional patent application entitled, “METHODS FOR DYNAMICALLY ASSIGNING CONTENT TO BE DISPLAYED ON A DIGITAL SIGN” which was filed contemporaneously herewith, the content of which is hereby incorporated by reference herein in its entirety.

### BACKGROUND

1. Field of the Disclosure

The present disclosure relates generally to digital signs and, more particularly, to methods and devices for dynamically assigning content to be displayed on a digital sign.

2. Description of the Related Art

Retailers have specific locations within a store where featured or sale items are given special emphasis. These are known as “power positions” and are typically in high-traffic areas. For example, the ends of the aisles or endcaps are power positions.

Signage is typically located at the power positions, highlighting a retail item and may include its description, image, and price. The signage also emphasizes characteristics of the item that persuade the customer to purchase the item, such as “20% off,” “sale,”, “clearance,” etc. The signage is typically constructed of paper or cardboard and may have disadvantages, including but not limited to, long lead time to order and receive, significant store labor to set up, inflexibility in that it cannot be quickly changed to feature another item, and lack of durability.

Sonic retailers are switching to digital signage instead of paper or cardboard signage. However, the digital signage does not have an easy, quick, and flexible way of generating signage content or causing that content to be displayed on the digital signs. What is needed are a system and methods that enable easy, flexible, and quick assigning of content to a digital sign on an ad hoc or unscheduled basis.

### SUMMARY

The present invention, in one form thereof, is directed to a system having a server, a digital sign communicatively coupled to the server, and a hand-held scanner. The digital sign has a first identifier. The hand-held scanner contains one or more instructions to scan the first identifier, scan a second identifier associated with a retail product, and transmit the first identifier and the second identifier to the server. The server contains one or more instructions to route a display data based upon the second identifier to the digital sign.

The present invention, in another form thereof, is directed to a hand-held scanner containing one or more instructions to: display a first prompt instructing a user to scan a barcode on a digital sign; scan a digital-sign barcode to generate a first identifier; display a second prompt instructing the user to scan a barcode on a retail product; scan a retail-product barcode to generate a second identifier; and transmit the first identifier and the second identifier to a display-data server.

The present invention, in yet another form thereof, is directed to a display-data server configured to: receive from a hand-held scanner a product identifier that identifies a retail product; receive from the hand-held scanner a sign identifier that identifies a digital sign; and route a display data to the digital sign identified by the sign identifier.

Other embodiments, objects, features and advantages of the disclosure will become apparent to those skilled in the art from the detailed description, the accompanying drawings and the appended claims.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. The accompanying drawings incorporated in and forming a part of the specification illustrate several aspects of the present disclosure and, together with the description, serve to explain the principles of the present disclosure.

FIG. 1 is a schematic diagram of a digital sign system according to one example embodiment.

FIG. 2 is a diagram of display data to be displayed on a digital sign according to one example embodiment.

FIG. 3 is a flowchart of a method of operating a digital sign according to one example embodiment.

### DETAILED DESCRIPTION

In the following description, reference is made to the accompanying drawings where like numerals represent like elements. The example embodiments are described in sufficient detail to enable those skilled in the art to practice the present disclosure. It is to be understood that the disclosure is not limited to the details of construction and the arrangement of components set forth in the following description or illustrated in the drawings. The disclosure is capable of other embodiments and of being practiced or of being carried out in various ways. For example, other embodiments may incorporate structural, chronological, electrical, process, and other changes may be made without departing from the scope of the present disclosure. Examples merely typify possible variations. Portions and features of some example embodiments may be included in or substituted for those of others. The following description, therefore, is not to be taken in a limiting sense, and the scope of the present disclosure is defined only by the appended claims and their equivalents.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Further, the terms “a” and “an” herein do not denote a limitation of quantity, but rather denote the presence of at least one of the referenced item.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block of the diagrams or combinations of blocks in the diagrams discussed in detail in the descriptions below.

These computer program instructions may also be stored in a non-transitory computer-readable memory that may direct a computer or other programmable data processing apparatus to function in a particular manner, such that the instructions stored in the computer-readable memory produce an article of manufacture including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the function specified in the block or blocks.

Accordingly, the blocks of the diagrams support combinations of means for performing the specified functions, combinations of steps for performing the specified functions and program instruction means for performing the specified functions. It will also be understood that each block of the diagrams, and combinations of blocks in the diagrams, can be implemented by special purpose hardware-based computer systems that perform the specified functions or steps or combinations of special purpose hardware and computer instructions.

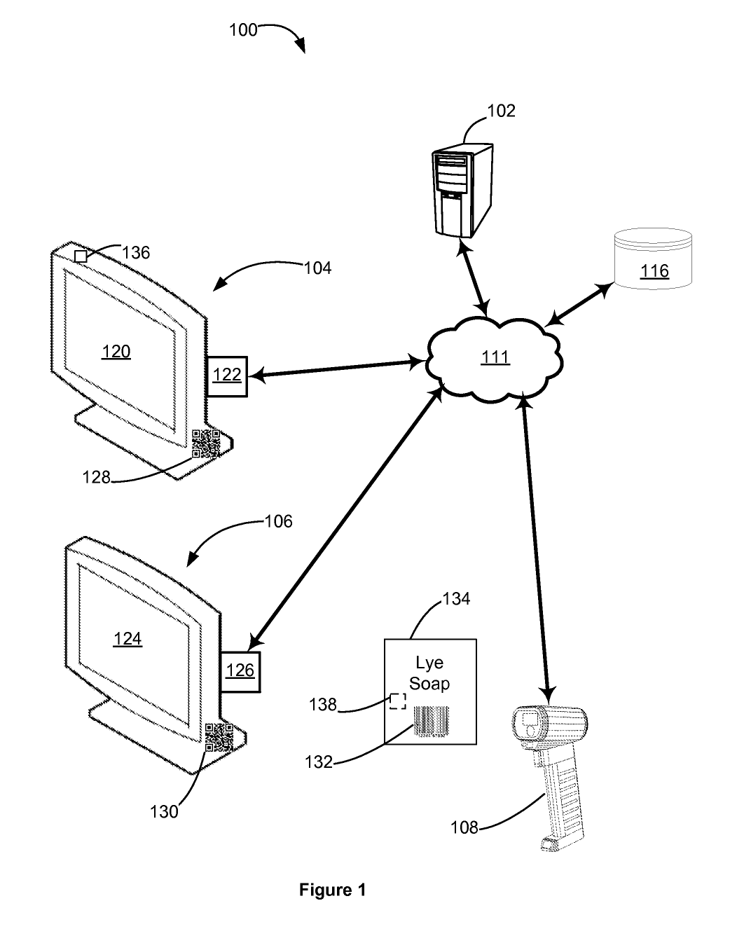

Referring now to the drawings and more particularly to FIG. 1, there is shown a schematic diagram depiction of a digital sign system 100 according to one example embodiment. Digital sign system 100 includes a server 102 e.g. a display-data server, a first digital sign 104, a second digital sign 106, and a hand-held scanner 108. Server 102 communicates with digital sign 104 over a network 111 via a communications link. Server 102 communicates with digital sign 106 via a communications link. Server 102 communicates with hand-held scanner 108 via a communications link. As used herein, the term “communications link” generally refers to any structure that facilitates electronic communication between multiple components and may operate using wired or wireless technology and may include communications over a network, such as the Internet. Server 102 is configured to run a server program, which will be described below in more detail.

As is known in the art, server 102 includes one or more processor units and associated memory and may be formed from one or more Application Specific Integrated Circuits (ASICs). The memory may be any volatile or non-volatile memory or combination thereof such as, for example, random access memory (RAM), read only memory (ROM), flash memory and/or non-volatile RAM (NVRAM). Alternatively, the memory may be in the form of a separate electronic memory (e.g., RAM, ROM, and/or NVRAM), a hard drive, a CD or DVD drive, or any memory device convenient for use with server 102.

In the example embodiment shown in FIG. 1, server 102 communicates with a price database 116 via a communications link. In this example embodiment, price database 116 is located in a piece of hardware that is separate from server 102. In some alternative embodiments, a price database may be integrated into the same hardware as server 102. Price database 116 may, for example, be integrated into the server program.

Digital sign 104 includes a display 120 and a controller 122. Display 120 may be a monitor, television or any other apparatus capable of displaying information to a user or customer. In operation, controller 122 receives display data from server 102 via a communication link and displays the display data on display 120. Controller 122 includes a processor unit and associated memory and may be formed as one or more Application Specific Integrated Circuits (ASICs). The memory may be any volatile or non-volatile memory or combination thereof such as, for example, random access memory (RAM), read only memory (ROM), flash memory and/or non-volatile RAM (NVRAM). Alternatively, the memory may be in the form of a separate electronic memory (e.g., RAM, ROM, and/or NVRAM), a hard drive, a CD or DVD drive, or any memory device convenient for use with controller 122. Like digital sign 104, digital sign 106 has a display 124 and a controller 126 that receives display data from server 102 via a communication link.

A sign identifier label 128 is affixed to digital sign 104. A barcode is printed on label 128. For this application, the term barcode refers to a machine-readable figure with one-dimensional encoding, such as a Universal Product Code (UPC), and also refers to a machine-readable figure with two-dimensional encoding, such as are described in U.S. Pat. No. 5,726,435 “Optically readable two-dimensional code and method and apparatus using the same.” The barcode on label 128 has a printed encoding of a unique identifier for digital sign 104. A sign identifier label 130 is also affixed to digital sign 106. A barcode is printed on label 130, and the barcode has a printed encoding of a unique identifier for digital sign 106. Note that the identifier for digital sign 106 is different than the identifier for digital sign 104. The sign identifier label 128 may alternatively be affixed to a shelf near digital sign 104, to a map of a store, etc.

Hand-held scanner 108, in this example embodiment, is configured to optically read barcodes as is known in the art. Hand-held scanner 108 is configured to run a scanner program. In operation, the scanner program scans a UPC 132 printed on a retail product or retail product packaging 134 to read the product identifier associated with that retail product 134. The scanner program also scans, for example, the barcode on label 128 to read the sign identifier associated with digital sign 104. The scanner program then sends both the product identifier and the scanned sign identifier to the server program. In some alternate example embodiments, hand-held scanner 108 may be a component of a multifunction computing device, such as a tablet, or mobile phone.

In operation, the server program receives the product identifier and the sign identifier from the scanner program. The server program generates display data based on the scanned product identifier. For example, the server program may read the price of the retail item from the price database 116, and the generated display data may contain this price. The server program then routes the generated display data to the digital sign that corresponds with the received sign identifier e.g., digital sign 104. The routing may take the form of, for example, writing the display data to a file location on the server that is associated with digital sign 104. Controller 122 reads the display data from this file location and displays the display data on display 120. In this way, the server program sends display data that is based on the sign identifier to the digital sign associated with the sign identifier. Alternatively, the server program may route the display data by sending the display data to controller 122 without writing the display data to a file on the server.

The example embodiment just described illustrates that the disclosed system enables easy, flexible, and quick assigning of content to a digital sign on an ad hoc or unscheduled basis. An operator may follow the simple process of scanning, with a hand-held scanner, a UPC on a retail product and then scanning, with the same hand-held scanner, a label on the desired target digital sign, to assign the content of the digital sign. Since this operation is simple, it may be performed quickly on an unscheduled basis by any store personnel. Since the hand-held scanner is portable and mobile, it may be used throughout the store to assign the content of multiple digital signs, enabling rapid storewide transitions of the digital signs.

Multiple digital signs may be assigned the same display data by scanning a UPC on a retail item then scanning labels on multiple digital signs. This will save time as compared to rescanning the same retail item for each digital sign. Advertisements for multiple retail items may be incorporated into a single advertisement, or may be incorporated into a single display data, to be shown on a digital sign. Identifiers for the multiple retail items may be scanned before or after scanning a digital sign identifier and the retail item identifiers and the digital sign identifier may be sent to a server.

Note that, in alternative example embodiments, the identifiers for the digital signs and for the retail items may be stored in something other than a printed barcode. For example, the identifiers may be stored in wireless communication modules e.g. a Bluetooth module 136, a RFID tag 138, etc. Of course, the hand-held scanner would contain the hardware necessary to read the wireless communication modules. The hand-held scanner may be a cell phone with a camera, in which case the barcodes may, for example, be read via the camera. An identifier may be a string of numbers, letters, and/or symbols. For example, the identifier for a digital sign may be the MAC address of a network adapter in the digital sign controller, a serial number, etc. The identifier for a retail product may be the associated stock keeping unit number (SKU) that may, for example, be scanned from a label on the shelving.

The scanner program may be stored on the hand-held scanner 108. Alternatively, the server program may be configured to send the scanner program to the hand-held scanner 108 to be run by the hand-held scanner 108.

The hand-held scanner may include a user interface having a display. The hand-held scanner may contain one or more instructions to display a prompt on the display instructing a user to scan a barcode on a digital sign and to display a prompt instructing the user to scan a barcode on a retail product. These prompts will help guide the user through the required actions, which will make the process accessible to a wider range of store personnel.

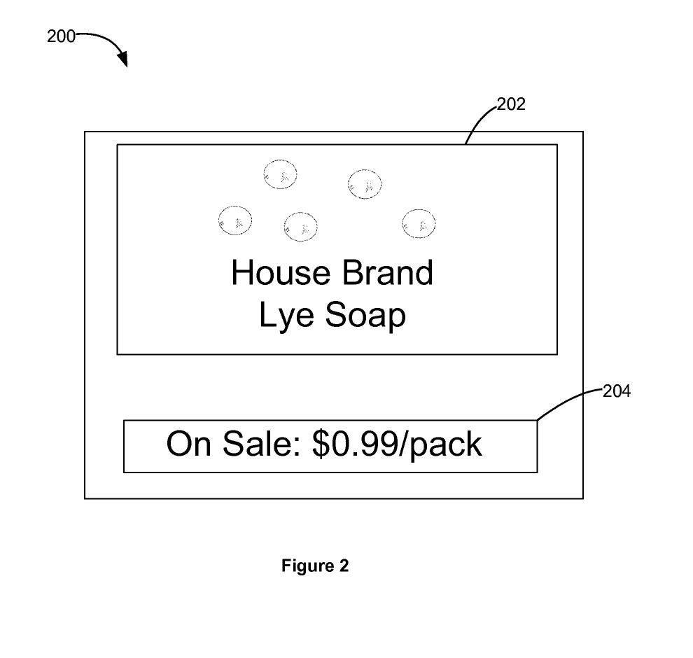

FIG. 2 shows a diagram of example display data to be displayed on digital sign 104. The display data 200, in this example, includes a graphic region 202 and a text region 204. Graphic region 202 may include an illustration or image related to the retail product 134. Text region 204 includes the price of the retail product 134. Text region 204 may include product information such as name of the product, size, etc.

To generate display data 200, the server program may use, for example, a template that defines the size and position of graphic region 202 and text region 204. The template may also include business rules and logic to implement the business rules. For example, in regions that restrict sales of alcohol on Sunday, the business rules may detect that the display data relates to an alcoholic retail item and thus insert a notice into the display data notifying customers on Sunday that the sale of alcohol is restricted. The server program may read the price of retail product 134 from price database 116 and insert this data into text region 204.

Note that display data 200 may include a static image, animated images, or both static and animated images. The display data 200 may also include a series of static images. The display data may contain three-dimensional images, two-dimensional images, or both three-dimensional images and two-dimensional images, Display data may he a non-compressed bitmap (e.g. BMP), a compressed image (e.g. JPEG), or high-level meta data that describes an image (e.g. PostScript), etc.

The server program may modify the display data 200 based on the physical characteristics of the digital sign system that correspond to the sign identifier. Such physical characteristics include, for example, display resolution, display aspect ratio, display size, vertical height above the floor, position within an aisle (e.g. power position vs. non-power position) and store section (e.g., produce, cans, meat, etc.).

In some example alternative embodiments, as an alternative to the server program reading the price of retail product 134 from price database 116, the scanner program may be configured to enable a user to manually enter a price using, for example, a keypad. The scanner program sends the server program the new price along with the product identifier and the scanned sign identifier. This new price may override the price in the price database 116 for the scanned sign, This gives individual retailers and stores the flexibility to adjust pricing for special events without requiring modifications to the price database 116.

In still other example alternative embodiments, the template used by the server program may be selected from a collection of available templates. The scanner program may be configured to enable a user to manually select a template having a unique template identifier. The scanner program sends the server program the template identifier along with the product identifier and the scanned sign identifier. The server program creates display data 200 using the identified template. This gives individual retailers or stores the flexibility to adjust the contents of their digital signs for special events.

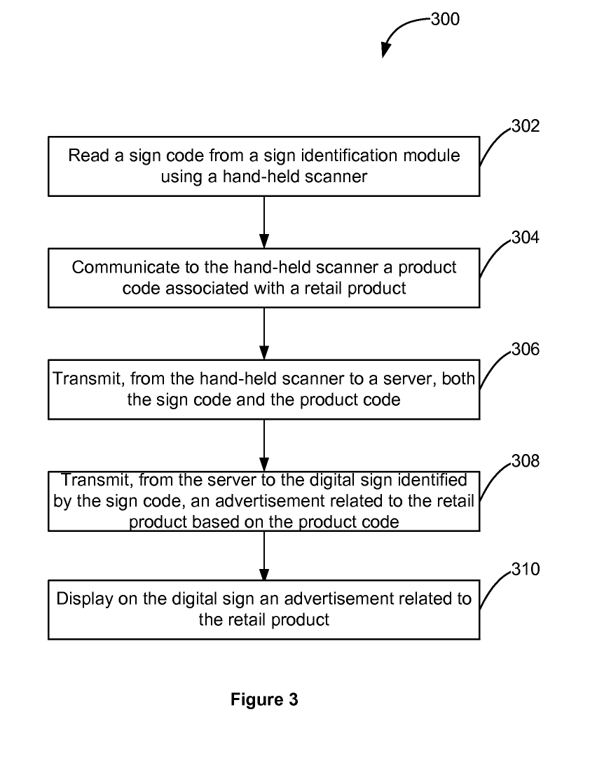

FIG. 3 shows one example method 300 of operating a digital sign. The digital sign has a sign identification module containing a sign identifier. For example, the digital sign may have sticker with a barcode, a RPM tag, etc. Method 300 enables easy, flexible, and quick assigning of content to a digital sign on an ad hoc or unscheduled basis. The method may be performed on a hand-held scanner, e.g. an optical scanner, a wireless module scanner, etc., and on a server.

At block 302, an operator reads a sign identifier from the sign identification module using a hand-held scanner. At block 304, the operator communicates to the hand-held scanner a product identifier associated with a retail product. The operator may communicate the product identifier in any number of manners, such as by scanning a UPC on the retail product, by selecting the retail product from a menu on the hand-held scanner, or by taking a picture of the retail product packaging illustrations and automatically finding a matching product identifier in a database, etc.

At block 306, the hand-held scanner transmits, from the hand-held scanner to a server, both the sign identifier and the product identifier. At block 308, the server transmits, from the server to the digital sign identified by the sign identifier, an advertisement related to the retail product based on the product identifier. At block 310, the digital sign displays on the digital sign information and/or an advertisement related to the retail product.

It will be appreciated that the actions described and shown in the example flowchart may be carried out or performed in any suitable order. It will also be appreciated that not all of the actions need to be performed in accordance with the example embodiments and/or additional actions may be performed in accordance with other example embodiments of the present disclosure. For example, in example method 300, block 304 may be performed before block 302.

The foregoing description illustrates various aspects and examples of the present disclosure. It is not intended to be exhaustive. Rather, it is chosen to illustrate the principles of the present disclosure and its practical application to enable one of ordinary skill to in the art to utilize the present disclosure, including its various modifications that naturally follow. Many modifications and other example embodiments of the disclosure set forth herein will come to mind to one skilled in the art to which this disclosure pertains having the benefit of the teachings presented in the foregoing description and the associated drawings. Therefore, it is to be understood that the present disclosure is not to be limited to the specific example embodiments disclosed and that modifications, variations and other embodiments are intended and contemplated to be included within the scope of the appended claims. Relatively apparent modifications include combining one or more features of various example embodiments with features of other example embodiments. Although specific terms are employed herein, they are used in a generic and descriptive sense only and not for purposes of limitation.

What is claimed is:

1. A system, comprising:
a server;
a digital sign communicatively coupled to the server, the digital sign having a first identifier; and
a hand-held scanner containing one or more instructions to
scan the first identifier,
scan a second identifier associated with a retail product, and
transmit the first identifier and the second identifier to the server,
wherein the server contains one or more instructions to route a display data based to upon the second identifier to the digital sign.

2. The system of claim 1, wherein the hand-held scanner contains one or more instructions to prompt a user to scan the first identifier and to scan the second identifier.

3. The system of claim 1, wherein the server contains one or more instructions to generate the display data using a template.

4. The system of claim 1, wherein the hand-held scanner contains one or more instructions to send a template identifier to the server and the server contains one or more instructions to use a template associated with the template identifier to generate the display data.

5. The system of claim 1, wherein the server contains one or more instructions to retrieve from a price database a price based on the second identifier and to generate the display data based on the price.

6. The system of claim 1, wherein:
the hand-held scanner contains one or more instructions to send a price to the server, and
the server contains one or more instructions to generate the display data based on the price.

7. The system of claim 1, wherein the first identifier is encoded in a barcode.

8. The system of claim 7, wherein the barcode has one-dimensional encoding.

9. The system of claim 7, wherein the barcode has two-dimensional encoding.

10. The system of claim 1, wherein the first identifier is stored in a wireless communication module.

11. The system of claim 1, wherein the second identifier is encoded in a barcode.

12. The system of claim 1, wherein the second identifier is stored in a wireless communication module.

13. A hand-held scanner containing one or more instructions to:
display a first prompt instructing a user to scan a barcode on a digital sign;
scan a digital-sign barcode to generate a first identifier;
display a second prompt instructing the user to scan a barcode on a retail product;
scan a retail-product barcode to generate a second identifier; and
transmit the first identifier and the second identifier to a display-data server.

14. The hand-held scanner of claim 13, wherein the hand-held scanner contains one or more instructions to send a template identifier to the display-data server to be used by the display-data server to generate a display data for the digital sign.

15. The hand-held scanner of claim 13, wherein the hand-held scanner contains one or more instructions to send a price to the display-data server to cause the display-data server to generate a display data for the digital sign containing the price.

16. The hand-held scanner of claim 13, wherein the hand-held scanner is a mobile phone.

17. A display-data server configured to: receive from a hand-held scanner a product identifier that identifies a retail product; receive from the hand-held scanner a sign identifier that identifies a digital sign; and route a display data to the digital sign identified by the sign identifier.

18. The display-data server of claim 17, further configured to send to the hand-held scanner one or more instructions to scan the product identifier, scan the sign identifier, and transmit the product identifier and the sign identifier to the display-data server.

19. The display-data server of claim 17, further configured to generate the display data.

20. The display-data server of claim 17, further configured to receive a template identifier and generate the display data using a template associated with the template identifier.
